(19) United States
(12) Patent Application Publication
(10) Pub. No.: US 2024/0118104 A1
(43) Pub. Date: Apr. 11, 2024

(54) METHOD AND DEVICE FOR PROCESSING SENSOR DATA

(71) Applicant: Siemens Mobility GmbH, München (DE)

(72) Inventor: Thomas Waschulzik, Freising (DE)

(21) Appl. No.: 18/263,560

(22) PCT Filed: Dec. 15, 2021
(86) PCT No.: PCT/EP2021/085888

§ 371 Date: Jul. 31, 2023

(30) Foreign Application Priority Data
Jan. 29, 2021 (DE) 10 2021 200 822.4

(51) Int. Cl. G01C 21/00

(52) U.S. Cl. CPC G01C 21/3837

(57) ABSTRACT

A method and a device for processing sensor data in a vehicle, and a vehicle. A scene from the surroundings of the vehicle is detected by sensors, and corresponding sensor data are generated. Objects in the scene are recognized as a result of processing the sensor data, and corresponding object data are generated which characterize the recognized objects. In order to be able to reliably assess the reliability of the scene recognition by sensors, the processing of the sensor data, the object recognition and/or the database, the generated object data are compared with quality-assured scene data which are stored in a database and which characterize objects in the scene.

The invention relates to a method and an apparatus for processing sensor data in a vehicle, and to a vehicle.

Processing sensor data is known for example in connection with driver assistance systems or even autonomously driving vehicles. With the help of a sensor device the area surrounding an at least partially autonomously driving vehicle can be detected, the corresponding sensor data analyzed and in this way objects recognized. The control of the vehicle can in this way be carried out at least partially on the basis of the recognized objects.

The functionality of systems for the autonomous or at least partially autonomous control of vehicles can be increased in this case if reference is additionally made to a map which contains information on the route traveled by the vehicle.

Digitized maps, which may be present in the form of databases, are used for example for route planning and/or monitoring of the progress of the journey in navigation devices. In this case it is also known not only for the information on the course of streets or roads to be stored in these databases, but also additional information about the area surrounding the streets, for example about what are known as “points of interest” such as gas stations, railroad stations, places of interest and/or the like.

In the case of what are known as HD maps, the corresponding databases contain a particularly large amount of such additional information. This additional information can in this case in particular characterize what are known as landmarks. The landmarks describe with an extremely high spatial resolution for example traffic signs, traffic lights, street lights, buildings and/or other noteworthy objects in the area surrounding streets or roads. Because of their high level of detail these maps can hence even be used for what is known as landmark-based navigation. In this case the sensor data generated during the detection of the area surrounding the vehicle can be aligned with the data from the corresponding database. Correspondences found can be used to determine the position of the vehicle extremely precisely. This can be utilized in order to keep a vehicle that is driving at least partially autonomously “on track”.

Alternatively or additionally, a map such as this can however also gather technical information relevant to driving, such as permitted maximum speed, priority rules, road condition and/or the like. In conjunction with the information contained in the sensor data about the area surrounding the vehicle, for example in respect of other transport users, the vehicle can then navigate at least partially autonomously.

It is an object of the present invention to make it possible to assess the reliability of the object recognition.

This object is achieved by a method and an apparatus for processing sensor data in a vehicle, and by a vehicle in accordance with the independent claims.

Preferred forms of embodiment form the subject matter of the dependent claims and of the following description.

In the inventive method for processing sensor data in a vehicle, in particular in a rail vehicle, a scene from the area surrounding the vehicle is detected by sensors and corresponding sensor data is generated. On the basis of data processing of the sensor data, objects in the scene are recognized and corresponding object data that characterizes the recognized objects is generated. The generated object data is compared with quality-assured scene data that is stored in a database and that characterizes objects in the scene. Depending on the result of the comparison the reliability of the scene detection by sensors and/or of the data processing of the sensor data and/or of the object recognition and/or of the database is assessed.

A scene within the meaning of the invention can be understood as a driving situation of the vehicle. In other words, a scene can represent a “snapshot” of the area surrounding the vehicle at a point in time. Thus a scene is expediently defined by objects from the area surrounding the vehicle and the arrangement thereof relative to one another and/or to the vehicle at a point in time.

Data processing of sensor data within the meaning of the invention can be understood as an analysis, in particular an algorithmic analysis, of the sensor data. In particular, the sensor data can be used to perform mathematical operations and/or pattern recognition. Data processing of sensor data is preferably performed by artificial intelligence, for example by a trained neural network and/or the like. Data processing of sensor data can in particular include processing of the data with the help of at least one algorithm for digital image processing.

Quality-assured scene data within the meaning of the invention can in particular be understood as data to which is attributed a particularly high degree of reliability. For example, the information contained in such data can be trusted to a particularly high extent. Quality-assured scene data can for example satisfy a specified safety standard, in particular one of several safety levels such as an SIL (Safety Integrity Level) for instance.

The scene data can for example characterize properties, also referred to below as features, of the objects. The quality assurance of the scene data expediently includes among other things that at least one combination of the properties or features is specific to each object characterized by the scene data. In particular, for quality-assured scene data it can be provided that the unique description of an object by at least one feature, in particular a combination of features, is assured as regards the specificity compared with other objects.

One aspect of the invention is based on the approach of monitoring the journey of a vehicle, in particular of a rail vehicle such as a train or at least a railcar or a locomotive, for example along a specified route on the basis of a database. The database in this case contains scene data that characterizes objects preferably in different scenes along the route. When monitoring the journey, objects in a scene are preferably identified from the area surrounding the vehicle on the basis of sensor data generated during the detection by sensors of the area surrounding the vehicle. Object data that is generated during the recognition of the objects with the help of data processing, in particular algorithmic data processing, and that characterizes the recognized objects is expediently compared with at least part of the scene data. Because thanks to the comparison the object data based on the sensor data is correlated with the scene data, the reliability of the scene detection by sensors and/or of the data processing of the sensor data, in other words of the recognition algorithm as such, and/or of the object recognition or identification is assessed. Alternatively or additionally, it is in this way also conceivable for the reliability of the database to be assessed.

When assessing the scene detection by sensors, the reliability of the sensor system is preferably assessed, i.e. for example whether a sensor device is working correctly.

When assessing the data processing of the sensor data the reliability of the method is preferably assessed, after which the sensor data is processed. For example, the reliability of a corresponding algorithm or of an artificial intelligence can be assessed. In the assessment of the object recognition the reliability of the result of the data processing is preferably assessed, i.e. for example whether an object has been allocated the correct properties.

When assessing the database the reliability of the scene data is preferably assessed, i.e. for example whether the scene data correctly maps reality.

When assessing the reliability, the scene detection by sensors and/or the data processing and/or the object recognition and/or the database is preferably assigned a reliability level. For example, depending on the result of the comparison of the scene data with the object data from the scene detection by sensors and/or the data processing and/or the object recognition a level for the reliability of the scene data can be assigned. In other words, the trust in the database can in this way be transferred to the sensor system of the vehicle, the algorithms used for data processing in the vehicle and/or the “virtual” scene based on the detection by sensors.

A level for reliability within the meaning of the invention can in particular be understood as a safety standard. Such a reliability level can for example correspond to one of several safety levels, for instance an SIL (Safety Integrity Level). The level for the reliability of the scene data is expediently dependent on quality assurance of the scene data, in particular defined by the quality assurance.

Thus it may be sufficient to carry out quality assurance of the scene data, in particular the specificity, with which the scene data characterizes objects and/or the properties thereof, in order to safeguard the operation of the object recognition. The level for the reliability of the scene data that can be associated with the quality assurance can be transferred to the scene recognition, the data processing and/or the object recognition. In contrast, it is possible to dispense with dedicated quality assurance of the scene recognition, the data processing and/or the object recognition, which in the case of the algorithms used in this case can be extremely complex.

If the object data substantially matches the scene data, it is possible for example to assume that the object recognition or object identification is robust. In contrast, if the object data does not sufficiently match the scene data, or not at all, it is possible to assume that the object recognition is faulty or defective. Since this directly affects the reliability for example of the control of a vehicle operated at least partially in an automated manner, in particular driverlessly, the comparison thus also allows the driving safety of such a vehicle to be assessed. In particular, depending on the result of the comparison, a level for the reliability of the scene data, in particular of the scene data contained therein, can be associated with the object recognition, in other words for example with the detection of the surrounding area and/or the recognition of the objects in the scene.

In (partially) automatic or driverless driving, it is normal that high safety requirements, where appropriate statutorily laid down, have to be satisfied. In particular, object recognition based on the sensor data can take place with a particularly high level of reliability. For automatic control systems to be approved, it may also be necessary to submit evidence of this reliability. This becomes possible by comparing the object data with the scene data. In particular, as a result it is also possible to check in normal operation, in particular in real time, whether the scene detection, the data processing and/or the object recognition is working reliably.

The safety of the correct scene detection, data processing and/or object recognition is preferably determined by matching a plurality of specific features of the objects detected by sensors and objects recorded in the database. If the specific features match to at least a, preferably specified, degree, it is possible to conclude that the overall system is functioning correctly.

Thanks to the correct recognition of an object at a position stored in the database it is also possible to determine the location of the vehicle, the calibration of sensors designed for detection, the functioning of the sensors and of the sensor fusion, the proper functioning of the hardware and software for information processing and communication. The information about the reliability of the individual components, in particular in the form of the result of the comparison, can for example be reported to a health management system of the object recognition, which reduces performance parameters when errors or restrictions are recognized. When visibility conditions are impaired by rain, fog, smoke or snow, in the event of soiling or because a subset of the sensors is no longer calibrated, it is possible for example to order a reduction in the permitted speed of the vehicle.

It is advantageous in this case if the underlying database or the scene data contained therein can be trusted to a particularly great extent. A database is therefore preferably used whose authorship is classed as reliable and/or which is correspondingly certified. The method is expediently based on a database that has been at least partially created or at any rate checked by a human operator. The database or the data contained therein expediently conforms to a specified safety standard, such as the DIN standard EN 61508.

By comparing the object data with the scene data it is also possible to use an algorithm which is “unsafe”, i.e. where appropriate not certified or not checked for reliability under all operating conditions, in the automation of vehicle functions for object recognition or identification of objects. So long as at least part of the object data matches the scene data at least substantially, in other words for example positions, structures and/or shapes of objects determined during the detection of the surrounding area by sensors, correspond to a description of the surrounding area in accordance with the scene data, the level of the reliability of the scene data can be associated with the object recognition, and the object data can be correspondingly used for example to control the vehicle. This is because when an object is correctly recognized at the expected position, in particular when it is recognized with a high degree of specificity, it can be assumed that there is a high probability of other objects also having been correctly recognized in the scene. The reason for this is that the probability of errors occurring that relate only to part of the section of the area surrounding the vehicle detected by a sensor device is extremely low compared with an error occurring that relates to the entire detection of the surrounding area. If many objects are correctly detected in quick succession in different sections of a detection range of the sensor device, the probability of errors decreases further, since sporadic failures, for example in camera sensors, are very rare and also soiling of the optics or limitations of the scanning function of a scanner can be ruled out with high degree of probability.

Object data which has no correspondence in the database can then in particular also be used to control the vehicle. It can particularly be assumed that such “additional” object data characterizes objects in the scene that are not recorded in the database. In this case the trust that was built up when objects recorded in the database were recognized can at least partially be transferred to the recognition of these “additional”, unknown objects. In the case of such objects this may for example also involve nonstationary objects such as for example people on a platform, animals on the track bed and/or the like, the occurrence of which along the route cannot be foreseen.

In a preferred form of embodiment the database forms the map of a route on which the vehicle is traveling, and the scene data contains map data from a section of the map. With the help of such a map the scenes to be expected during the journey of the vehicle can be determined particularly reliably and precisely and the corresponding scene data can be used as a basis for the comparison.

In a further preferred form of embodiment, when assessing the reliability of the scene detection by sensors and/or of the data processing of the sensor data and/or of the object recognition and/or of the database a level of reliability is determined which is ascertained by the amount of scene data. In other words, the level of reliability preferably depends on the amount of information that is contained in the scene data. The scene data can for example have what are known as feature vectors for each object in the scene, wherein the feature vectors preferably have specific features of the detected objects as entries. The length of the vectors, i.e. the number of features described thereby, then corresponds expediently to the level of reliability. A large amount of scene data allows objects in the scene that are recognized on the basis of the sensor data to be validated with a high degree of reliability.

In particular, thanks to a combination of features an object recognized on the basis of the sensor data can be identified with a high degree of certainty in the database, i.e. can be associated with an object recorded in the database. As a result, evidence of the presence of the object in the sensor data can be provided.

The feature vectors corresponding to the scene data are expediently overdetermined. This means that a subset of specific features contained in the feature vectors is sufficient in order to uniquely recognize the object. As a result, the robustness during the comparison with the object data or the feature vectors corresponding to the object data can be increased.

In a further preferred form of embodiment, when comparing the object data with the scene data a degree of conformity for the match between the object data and the scene data can be determined. The degree of conformity can also be understood as a degree of confidence that characterizes the reliability of the recognition of the objects in the area surrounding the vehicle, in particular the strength of deviations between the object data and the scene data. In other words, using the degree of conformity it is possible to indicate a specificity with which an object is recognized on the basis of the sensor data. Using the degree of conformity the reliability of the object recognition is particularly easy to assess. In particular, on the basis of the degree of conformity the information about the reliability of the object recognition can be further processed particularly efficiently or used to control the vehicle.

The degree of conformity can for example assume a large value if not only objects that are also characterized by the scene data are characterized by the object data, but also if the characterization by the respective data substantially matches. The scene data can for instance contain not only information about the position of an object, but also about further quality-assured features, the traceability and specificity of which can be proved to an expert. The scene data can for example also contain information about the shape, structure, extent, texture, color and/or the like of an object. The larger the proportion of this information that matches corresponding information in the object data, the larger the determined degree of conformity can be. Accordingly, the determined degree of conformity can assume a small value if the information and shape contained in the object data about a position of a detected object substantially matches the corresponding information in the scene data, but the information about the extent and texture does not.

A check is expediently made as to whether the degree of conformity reaches or exceeds a specified threshold value for conformity. The threshold value for conformity can serve as an indicator of whether a number, specified as sufficient or safe, of properties of a recognized object matches the information contained in the scene data. If so, it is possible to assume that the objects have been safely recognized. From this it is possible to infer for example the safety of the position determination of the vehicle, the reliable and exact functioning of the sensor system for detecting and determining the object positions and where appropriate the correct calibration of multiple sensors with one another. If this is not the case, it can be assumed that the object has not been correctly recognized.

The threshold value for conformity in this case preferably depends on the safety requirements or can be selected as a function thereof. If the threshold value for conformity is selected to be large and is reached or exceeded by the degree of conformity, it is possible in principle to associate a high level of safety with the object recognition. If the threshold value for conformity is selected to be smaller and is reached or exceeded by the degree of conformity, in contrast only a low level of safety can be associated with the object recognition.

It can in particular be provided that the vehicle is controlled on the basis of the degree of conformity. The control expediently takes place as a function of the result of the check as to whether the degree of conformity reaches or exceeds the specified threshold value for conformity. If so, error-free object recognition can be assumed and the object data determined in this case can be used to control the vehicle. If in contrast the degree of conformity falls below the threshold value for conformity, it is possible to assume faulty or incorrect object recognition. In this case the object data should not be used to control the vehicle. Instead, it may be necessary to transfer the vehicle into a safe state, at least if no redundant system for controlling the vehicle is available or this is likewise impaired. Depending on the degree of conformity, the vehicle can in this way for example be stopped, because the object data is classed as no longer reliable. Alternatively or additionally, the sensor data can likewise be stored in a training database for follow-up training of the object recognition, together with at least part of the scene data, for example the information as to which objects with which properties should actually have been recognized.

Alternatively or additionally, it can be provided that the degree of conformity, in particular the degree of conformity output, is logged. For example, the degree of conformity, in particular the progress over time of the degree of conformity, can be stored. As a result, the reliability of the scene detection and/or data processing of the sensor data and/or of the object recognition and/or of the database can be verified. The degree of conformity logged can for example be presented to a public authority or an expert, in order to obtain an approval for a control system for the vehicle which is at least partially based on the object data.

The reliability can be significantly more efficiently verified using the degree of conformity than by a conventional direct analysis for example of the algorithm underlying the object recognition, or the source code of said algorithm. A source code analysis such as this normally entails considerable effort. Besides this, the determination of the degree of conformity also has the advantage that it can provide evidence of reliability substantially in realtime and thus even during the normal operation of the vehicle or of the corresponding control system.

Alternatively or additionally, the degree of conformity can also serve as a basis for increasing or at least preserving the trust in the database and the scene data contained therein. When there is a high degree of conformity it is possible in fact not only to assume that the object recognition is functioning reliably, but also that the database is correct. If the degree of conformity is logged, the logged degree of conformity can be used when the database is subsequently used again to monitor the journey of the same vehicle or of another vehicle, in order to prove the reliability of the database. In particular, the logged degree of conformity can be understood as a certificate of the database.

In a further preferred form of embodiment the generated object data or the scene data is compared, in particular additionally, with dynamic data provided by at least one object in the area surrounding the vehicle. Depending on the result of the comparison of the provided dynamic data with the object data or the scene data, the reliability of the scene detection by sensors and/or of the data processing of the sensor data and/or of the object recognition and/or of the database is preferably assessed. For example, depending on the result of the comparison a degree for the reliability of the dynamic data can be associated with the scene detection and/or the data processing and/or the object recognition and/or the database. The dynamic data can be transferred wirelessly from the at least one object to the vehicle. It is for example conceivable for a train approaching the vehicle, personnel working on the track bed for maintenance purposes, a tool for maintenance such as brake shoes and/or the like to transfer dynamic data to the vehicle, with which the generated object data can then be compared. Alternatively or additionally, it is however also conceivable for the dynamic data to be transmitted to the database, in particular in real time, and to be incorporated into the database. By taking account of the dynamic data, scenes containing dynamic objects can also be used for quality assurance of the object recognition.

In a further preferred form of embodiment, depending on the result of the comparison of the generated object data or the scene data with the provided dynamic data the reliability of the dynamic data can be assessed. In particular, a degree of reliability associated with the reliability of the scene recognition and/or of the data processing of the sensor data and/or of the object recognition and/or of the database can be associated with the dynamic data. The degree of the reliability of the scene data, which in one possible form of embodiment is or has been, on the basis of the comparison of the object data with the scene data, associated with the scene recognition and/or the data processing of the sensor data and/or the object recognition, is preferably also associated with the dynamic data. If for example an object is recognized at a correct position—i.e. a position validated by the scene data—the dynamic data can as a result also be quality-assured if it matches the object data and/or the scene data. The vehicle and the object can as a result form what is known as a community of dependability.

Quality assurance such as this of the dynamic data can also be provided for the object itself and/or to further vehicles or other transport users. As a result, the vehicles or transport users can for example have their sensors validated independently of other vehicles or transport users. This enables the reliability of the entire system to be increased, i.e. of the system made up of vehicles and objects that provide such dynamic data or form part of the community of dependability. In addition, errors, for example in the sensor system for detecting the scene or the object recognition, can be recognized or diagnosed more quickly and reliably.

In a further preferred form of embodiment a position of the vehicle on a route is determined and the scene made up of the area surrounding the vehicle at the determined position is detected. Using the determined position the relevant scene data from the database can be identified particularly efficiently and provided for the comparison. Accordingly, the generated object data is compared with the scene data stored in the database that characterizes objects in the area surrounding the determined position of the vehicle.

Unlike conventional navigation methods, for instance landmark-based navigation, with the help of the database not only is the position of the vehicle determined here and/or information read from the database used directly to control the vehicle. Instead, the position of the vehicle can be used for a comparison of the object data with the route data. In this case the position can be determined on the basis of conventional methods or methods known from the prior art, for instance on the basis of GPS signals.

The scene data is expediently filtered on the basis of the determined position. Filtered scene data is preferably provided for the comparison with the object data. As a result, it can be ensured that the object data is only compared with the scene data that characterizes objects in the area surrounding the vehicle at the determined position. In other words, it can in this way be ruled out that the object data is compared with scene data that characterize objects that are situated in a different section of the route.

If on the basis of the comparison a recognized object can be identified with an object recorded in the database, but the recognized position of the object deviates slightly from the position stored in the database, then depending on the trustworthiness of the information originating from the other sources either (i) the determined current position of the vehicle can be corrected, (ii) if the deviation is established only for one recognized object, the stored position information can be adjusted in the database or (iii) a calibration or alignment of a sensor device, for example a camera, in relation to the vehicle can be adjusted. Which correction or adjustment (i), (ii) or (iii) is performed is preferably determined on the basis of error models.

In a further preferred form of embodiment hazard objects in the area surrounding the vehicle are determined on the basis of the result of the comparison. A hazard object should here in particular be understood as an object that can (negatively) affect the journey of the vehicle. A hazard object can therefore in particular be hazardous for the vehicle and/or can be endangered by the vehicle.

The hazard objects selected in this way are preferably used in a hazard assessment. A hazard assessment should here be understood in particular as an analysis and assessment of the scene in respect of a hazard to the vehicle and/or to an object.

The hazard objects are expediently selected from objects that are characterized by the object data. In this case objects are preferably selected that are recognized on the basis of the sensor data, but that are not characterized by scene data. In other words, a classification as regards the hazard to the vehicle and/or the objects is preferably not restricted to objects recorded in the database. As a result, the number of the objects used for the hazard assessment can be significantly reduced. In particular, it can in this way be ensured that in an analysis of the scene only objects to which a hazard potential might actually be assigned are taken into account. Accordingly, a more efficient hazard assessment becomes possible.

Landmarks and thus stationary objects such as the track system, sets of signals, structures, and/or the like are typically recorded in the database. Such objects are also referred to as previously known objects and generally do not represent a hazard to the journey of the vehicle. Nor do they hence need to be taken into account for a hazard assessment. In contrast, mobile objects such as for example people on a platform or animals on the track bed are normally not recorded in the database. The number of objects to be checked for a possible hazard is reduced significantly by precisely these mobile and a priori unknown objects being identified and selected when comparing the object data with the scene data.

Alternatively or additionally, the hazard objects used for the hazard assessment can also be selected on the basis of the object data, in particular on the basis of a distance from the vehicle. As a result, the number of the objects to be taken into account for the hazard assessment can be further reduced.

Preferably the only objects used for the hazard assessment are those that are located at a specified distance, in particular in a specified distance range, from the vehicle. For example, on the basis of the comparison of the object data with the scene data all mobile objects in the area surrounding the vehicle can initially be selected and this selection then reduced to those mobile objects that are located at the specified distance from the vehicle. In this way objects that are not recorded in the database but that are too far away from the vehicle to represent a hazard can be excluded from the hazard assessment. As a result, the hazard assessment can take place even more efficiently.

In a further preferred form of embodiment, a surplus list of all objects characterized by the object data that are not characterized by scene data is determined during the comparison. In other words, on the basis of the comparison a list of objects in the area surrounding the vehicle can be drawn up that are not recorded in the database. These objects can for example involve mobile objects such as people on a platform, animals on the track bed and/or the like. The surplus list is then preferably output at least as part of the result. The surplus list allows an analysis of the driving situation at the determined position of the vehicle to be reduced to relevant objects. For example, the objects used for the hazard assessment can be selected on the basis of the surplus list.

It can in particular be provided that the vehicle is controlled on the basis of the surplus list. A control system of the vehicle can for example be designed to take account only of the objects contained in the surplus list for the control of the vehicle. This is based on the idea that there is no need to react with surprise to objects that are recorded in the database and are thus previously known. As a result, particularly efficient control of the vehicle can be achieved.

In a further preferred form of embodiment, further, in particular additional, object data of a recognized object is determined on the basis of the scene data. Preferably in this case further object data is determined in particular for objects not characterized by the scene data. Alternatively or additionally, the object data can also be supplemented on the basis of the scene data. As a result, the reliability for the recognition of objects on the basis of the sensor data, in particular for the generation of the corresponding object data, can be further increased.

For example, the position of objects recognized on the basis of the sensor data and that are not recorded in the database can be determined more precisely on the basis of a position relative to a recognized object that is recorded in the database. For instance, if on the basis of the sensor data a person is recognized in the vicinity of a set of signals, and the set of signals is recorded in the database, the distance of the vehicle from the person can be derived from the distance, characterized by the corresponding scene data, between the set of signals and the vehicle.

The object data of newly recognized objects that are not recorded in the database is preferably stored—at any event if they are stationary—in the database as preliminary scene data. These objects can alternatively or additionally be entered into a candidate list. If these objects are encountered at the same position on multiple journeys they can be transferred to a checklist and/or the preliminary scene data then undergoes a quality check and where appropriate is permanently added to the database.

In a further preferred form of embodiment the database at least meets DIN standard EN 61508, in particular in the version dating from 2010. The database preferably at least has a safety integrity level (SIL) of 1. This safety integrity level then for example applies for the error disclosure function for sensor systems for obstacle recognition and for simplification of scenes for obstacle recognition systems and for checking the position of vehicles. Thanks to the safety integrity level 1 it can be assumed that with constant use of the database and corresponding quality assurance a maximum of one error will occur in around 11 years. Accordingly, a particularly large amount of trust can be placed in the result of the comparison of the object data with the scene data. In particular, it can be assumed that when it is established that at least part of the object data matches the scene data the object recognition is error-free with an equally high probability.

In a further preferred form of embodiment a check is made when comparing the object data with the scene data as to whether object properties match. For this purpose, at least one feature vector corresponding to the object data is expediently compared with a feature vector corresponding to the scene data. Thus for example a check can be made as to whether a position of the recognized object relative to the vehicle matches a structure, in particular a topology, of the recognized objects and/or a shape of the recognized objects with corresponding properties of objects recorded in the database. A check is preferably made as to whether there are deviations between the object properties and where appropriate how large they are. In particular, the degree of conformity can be determined on the basis of the object properties or the deviations thereof.

Examples of further properties that can be checked include an expansion, change of shape (in the case of vegetation for instance because of growth, change of season, pruning, harvest and/or the like), color, temperature, temperature relative to the surrounding area, reflexivity and/or the like. These properties too can be present in the database as part of the scene data in the form of a feature vector. The feature vector preferably has a minimum size, i.e. a minimum number of entries, so that a chance matching of the features of objects recorded in the database with the properties characterized by the object data is so unlikely that this situation can be ruled out with sufficient certainty.

In a further preferred form of embodiment a point in time of the detection by sensors of the area surrounding the vehicle is determined and is used for the comparison of the object data with the scene data. As a result, it is possible too to include dynamic events or processes in the comparison. The trust in the object recognition can thus once again be increased.

For example, the change between day and night and/or the change of season can be included in this way. In the dark, certain objects or at least parts thereof may sometimes no longer be recognizable. For this it is conceivable for specific light sources, such as position lights, signal lights and/or the like, to be used for recognition. The changes in the vegetation caused by the change of season, for example in the form of harvested fields or leafless trees, can likewise be taken into account.

For example, it can be taken into account in this way that an object is located in the vicinity of the vehicle at the determined position only at a specified point in time or at least within a specified period of time. Such an object can for instance be a train which is approaching the vehicle as scheduled at the determined position. If the vehicle passes the same position at a different point in time, it will in contrast not meet the (scheduled) train (at this position).

The scene data is expediently filtered on the basis of the determined point in time. Thus scene data for which a priori no correspondence can be found in the object data on the basis of the determined point in time can be excluded from the comparison.

In a further preferred form of embodiment, depending on the result of the comparison at least part of the scene data is included in an, in particular renewed, recognition of further objects in the scene on the basis of the sensor data. If on the basis of the sensor data particular objects are not found, but which are characterized by scene data, it is does not necessarily mean that the reliability of the object recognition is deficient. If for example the degree of conformity for objects that are characterized both by the scene data and the object data assumes a high value, it is possible to search in the sensor data for precisely these objects at the position of objects characterized by the scene data, but not by the object data, in order to complete the scene and in this way further to simplify the interpretation of the driving situation. A renewed “search” such as this for further objects in the sensor data may make sense for example if an object is at least partially concealed by a different, mobile object.

The inventive apparatus for processing sensor data in a vehicle, in particular in a rail vehicle, has a sensor device that is designed to detect a scene in the area surrounding the vehicle and to generate corresponding sensor data. Moreover, the apparatus has a data processing device that is designed to recognize objects in the scene on the basis of data processing of the sensor data and to generate corresponding object data that characterizes the recognized objects.

In accordance with the invention the data processing device is moreover designed to compare the generated object data with scene data that is stored in a database and is quality-assured, and that characterizes the objects in the scene, and depending on the result of the comparison to assess the reliability of the scene detection and/or of the data processing of the sensor data and/or of the object recognition and/or of the database.

With the help of the data processing device designed in this way the scene detection, the data processing, the object recognition or identification and/or the database can be efficiently checked and assessed as regards reliability.

The data processing device can be designed in terms of hardware and/or software. For example, it can have one or more programs or program modules. Alternatively or additionally, it can have a data-connected or signal-connected processing unit, in particular a digital processing unit, preferably with a memory system and/or bus system, for instance a microprocessor unit (CPU). The CPU can in particular be designed to execute commands that are implemented as a program stored in a memory system. The data processing device can in particular be designed to carry out at least part of the inventive method.

In a preferred form of embodiment the device has a memory device, in which the database is stored. The memory device can have one or more, in particular different, storage media. The memory device can in particular have optical, magnetic, solid-state and/or other nonvolatile media.

The inventive vehicle, in particular a rail vehicle, has an inventive apparatus.

With the help of the apparatus the journey of the vehicle can be monitored particularly reliably and efficiently. In particular, scene detection, data processing and/or object recognition or identification, preferably used to control the vehicle, can be monitored and assessed in respect of their reliability.

The description given above of advantageous embodiments of the invention contains numerous features that are reproduced, in some cases several combined, in the individual subclaims. These features can however also expediently be considered separately and combined to form meaningful further combinations. In particular, these features can each be combined individually and in any suitable combination with the inventive method and the inventive apparatus as well as the vehicle. In this way method features can, objectively formulated, also be seen as a property of the corresponding apparatus unit and vice versa.

The properties, features and advantages described above of this invention as well as the way in which they are achieved will become clearer and more readily comprehensible in connection with the following description of the exemplary embodiments that are explained in greater detail in connection with the drawings. The exemplary embodiments serve to explain the invention and do not restrict the invention to the combinations of features specified therein, also not in respect of functional features. In addition, suitable features of each exemplary embodiment can to this end also be explicitly considered in isolation, removed from one exemplary embodiment, introduced into another exemplary embodiment to supplement it and combined with any of the claims.

In the drawings:

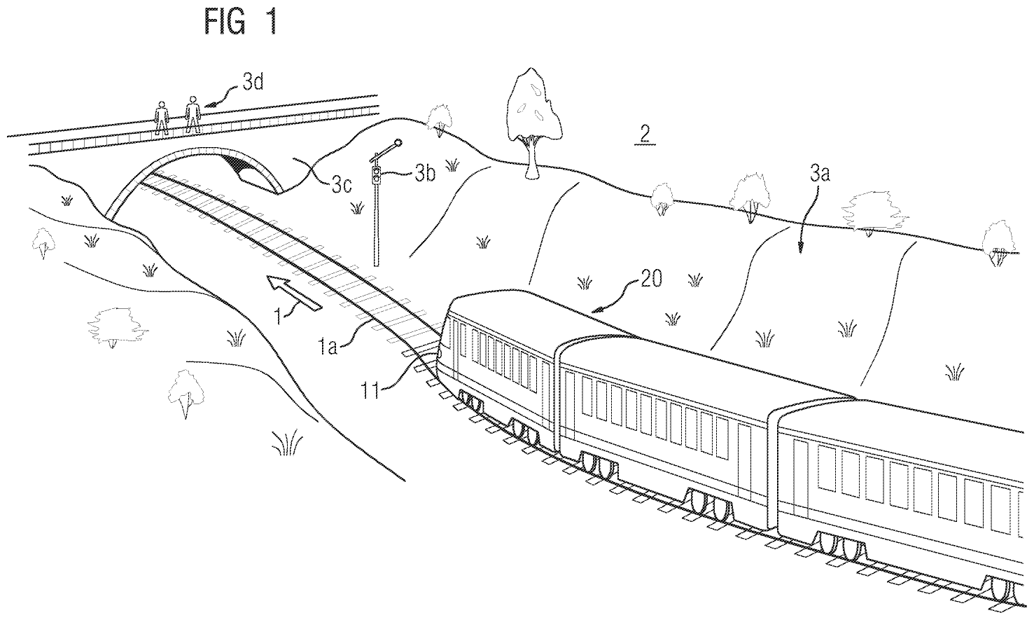

FIG. 1 shows an example of a driving situation from the perspective of a vehicle on a route;

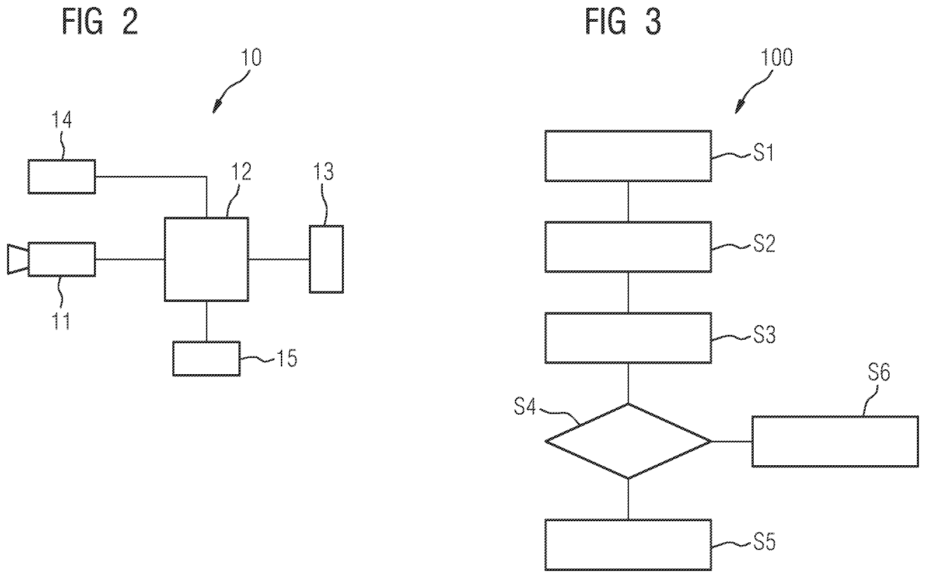

FIG. 2 shows an example of an apparatus for processing sensor data in a vehicle; and

FIG. 3 shows an example of a method for processing sensor data in a vehicle on a route.

FIG. 1 shows an example of a driving situation from the perspective of a vehicle 20 on a route 1. In the present case the vehicle (20) is a rail vehicle (also called a “rail-bound vehicle”), for instance a train, so that the route 1 is specified by the course of rails 1a.

The driving situation is preferably characterized by objects 3a, 3b, 3c, 3d in the surrounding area 2 of the vehicle 20. In particular, the driving situation can be characterized by the arrangement of the objects 3a, 3b, 3c, 3d relative to the vehicle 20. Hence the driving situation is occasionally also referred to as a scene.

The objects shown in FIG. 1 purely by way of example are an embankment 3a on the track bed, a set of signals 3b to control the rail traffic on the route 1, a structure 3c—here a bridge over the track bed—and people 3d.

In the course of the journey of the vehicle 20 along the route 1 a plurality of such driving situations will arise, which differ from one another in each case by the arrangement of the objects 3a-3d, the number of the objects 3a-3d, the type of the objects 3a-3d, etc. To control the vehicle 20 it is hence generally necessary to monitor the surrounding area 2 of the vehicle 20 at each point in time during the journey, in order where appropriate to be able to respond to impending hazards to the vehicle 20 caused by objects 3a-3d and/or to hazards to objects 3a-3d, in particular people 3d, caused by the vehicle 20 and to avert them.

For this purpose vehicles, in particular vehicles driving autonomously or at least partially autonomously with the help of a corresponding control system, are preferably fitted with a sensor device 11 that is designed to detect the surrounding area 2 and for example can have one or more camera sensors, radar sensors, lidar sensors and/or the like. In this case generated sensor data can be evaluated, for example with the help of algorithms for recognition of the objects 3a, 3b, 3c, 3d, and in this way the driving situation or scene can be analyzed.

In principle the objects 3a-3d can be divided into two groups: previously known objects 3a-3c and unknown objects 3d. Previously known objects 3a-3c can for example be stationary objects that occur on every journey of the vehicle 20 along the specified route 1, in particular always in the same position. Unknown objects 3d can be dynamic objects that by chance are located in the surrounding area 2 when the route 1 is traversed.

The occurrence of the previously known objects 3a-3c in the surrounding area 2 along the route 1 can easily be predicted on the route 1. It is in particular possible to provide a database in which for example all stationary objects 3a-3c are recorded. A database such as this can contain scene data that characterizes the stationary objects 3a-3c. The scene data for example contains the information about which of the previously known objects 3a-3c is located in which route section on the route 1 and in which arrangement relative to the vehicle 20.

However, previously known objects 3a-3c a priori play a lesser role in an analysis of the driving situation, for example for a hazard assessment, than unknown objects 3d. Stationary objects 3a-3c cannot for example directly influence the journey of the vehicle 20 along the route 1. In contrast, more attention often has to be paid to the analysis of unknown objects 3d, since in extreme cases these can also occur in the trackway of the vehicle 20, thus for example on the track bed.

Dynamic objects 3d may however often not be recorded in the database, since their occurrence in the surrounding area 2 along the route 1 or their arrangement relative to the vehicle 20 is not predictable. Exceptions to this are possible, in particular in respect of dynamic objects that relate to a regularly occurring event and/or are designed to provide dynamic data that characterizes them. For example, a scheduled train could be recorded in the database that meets the vehicle 20 on the route 1 in a specified route section. It is in particular conceivable for this train to transmit dynamic data, which for example contains information on the current position, on the direction of movement and/or on the type of train, to the vehicle 20 via a radio connection or another communication connection. Where appropriate, on the basis of this information further data, for instance on specific features of the train, can then be read from the database. Alternatively, this information can likewise be transmitted directly from the train to the vehicle 20.

Another example is a scheduled airplane that on particular days at a particular time is visible in the sky from the vehicle 20 from a specified route section.

The transmission of the dynamic data is preferably assured via a safety protocol. Alternatively or additionally, the dynamic data can itself be quality-assured.

To simplify the analysis of the driving situation, in particular to reduce the number of objects 3a-3d in the surrounding area 2 of the vehicle 20 that are used in a hazard assessment, it is advantageous to access the information contained in the database and when objects 3a-3d are recognized on the basis of the sensor data to compare generated object data with scene data stored in the database. As a result, previously known objects 3a-3c can be removed from the scene, which significantly simplifies and/or speeds up the analysis of the scene.

In particular the further track system, thus for example the course of the track bed 3a, is preferably determined from the sensor data. This is advantageous because the track system can be characterized particularly well and can thus be comparatively easily or reliably detected by sensors. If the track system is validated by the comparison with the scene data, the position of objects 3b, 3c, 3d recognized in the surrounding area 2 of the vehicle 20 relative to the track system can thereby for example be determined particularly reliably. Also for objects 3c, 3d at larger distances it is thereby possible to assess reliably whether they are situated on or near the track system, in other words for instance on the track bed 3a.

Accessing the scene data stored in the database during the scene analysis has a further advantage: the comparison of the object data with the scene data can provide indications regarding the reliability of the scene detection, the data processing of the sensor data, the object recognition and/or even of the database itself. If objects are recorded in the database that are not recognized during the processing of the sensor data, this may be an indication of a faulty or at least defective object recognition. Accordingly, the control of the vehicle 20 should no longer be based on the object data generated during the object recognition, since this is to be regarded as unreliable. Instead the vehicle 20 should be transferred to a safe state, in other words for example stopped. However, where appropriate this may also be an indication of an obsolete database. The database can then be correspondingly updated, for example after the absence of the objects has been checked by other vehicles.

FIG. 2 shows an example of an apparatus 10 for processing sensor data in a vehicle, in particular in a rail vehicle. With the help of such an apparatus 10 it is for example possible to monitor the journey on the route from FIG. 1. For this purpose the apparatus 10 has a sensor device 11 which is designed to record a scene from the area surrounding the vehicle and to generate corresponding sensor data, as well as a data processing device 12. The data processing device 12 is designed to process the sensor data, so that objects in the scene are recognized on the basis of the sensor data, and corresponding object data which characteries the recognized objects is generated.

The sensor device 11 expediently has one or more sensors, in particular of an optical type. The sensor device 11 can for example have a camera which is designed to generate sensor data in the form of an image of the surrounding area when the area surrounding the vehicle is detected. Likewise, the sensor device 11 can have one or more lidar sensors, radar sensors and/or imaging devices for the infrared and/or ultraviolet spectral range.

To recognize objects in such an image the data processing device 12 preferably has an algorithm for object recognition or can apply such an algorithm to the sensor data. With such an algorithm the recognized objects can be classified and properties of the objects such as for instance their position relative to the vehicle, size, structure or topology and/or the like can be determined. The object data expediently contains this information.

The data processing device 12 has access to a database 13 in which scene data is stored. The scene data in particular characterizes previously known, for example stationary, objects in the scene. The database 13 can, but need not, be part of the apparatus 10. The database 13 can for example also be held by a server with which the data processing device 12 installed in the vehicle can communicate.

Moreover, in the present example the apparatus 10 has a position determination device 14 which is designed to determine the (current) position of the vehicle on the route. The position determination device 14 can for example be designed as a GPS receiver or the like, in order to establish the position of the vehicle on the basis of signals received. Alternatively or additionally, odometry data of the vehicle can also be used.

The data processing device 12 is preferably designed to link the position determined by the position determination device 14 with the object data generated during the recognition of the objects. The object data can as a result be uniquely assigned to a position of the vehicle on the route. In this case the object data can hence also be referred to as position-specific or location-resolved object data.

It is further preferred if the data processing device 12 is designed to use the determined position of the vehicle on the route to compare the object data with the scene data. In other words, the data processing device 12 is preferably designed to compare the object data with the scene data in respect of the determined position of the vehicle. The data processing device 12 can in particular be designed to compare the object data with the scene data that characterizes objects in the area surrounding the determined position of the vehicle. To this end, an assignment of the scene data to possible positions of the vehicle along the route is expediently provided for in the database 13.

The data processing device 12 can for example be designed to filter the scene data in respect of the determined position. The data processing device 12 is expediently designed to remove from the database 13 the particular scene data that is assigned to the determined position. Alternatively, the data processing device 12 can be designed to pick out from the scene data removed from the database 13 the particular scene data that is assigned to the determined position.

By comparing the object data generated during the recognition of the objects with the scene data the actual driving situation, as is mapped by the sensor data, can accordingly be compared with a hypothetical driving situation, as is expected.

The data processing device 12 is designed to assess, on the basis of the result of the comparison, the reliability of the scene detection by sensors and/or of the data processing of the sensor data and/or of the object recognition and/or of the database. In particular, the data processing device 12 can be designed to associate a degree of reliability of the scene data 13 with the scene detection by sensors and/or the data processing of the sensor data and/or of the object recognition. The apparatus 10 expediently has an interface 15, with the help of which the result of the comparison can be provided.

The result can in particular contain a surplus list of all recognized objects that were recognized on the basis of the sensor data but are not recorded in the database 13 or at least are not assigned to the determined position. The result can in apparatus particular contain filtered object data. The result then expediently contains only that part of the object data for which the data processing device 12 was unable to determine any match with the scene data.

The data processing device 12 can provide this surplus list or the filtered object data to a control system, for example, via the interface 15. The control system can perform an analysis of the driving situation, in particular a hazard assessment, on the basis of the surplus list or of the filtered object data. On the basis of the analysis the vehicle can be controlled by the control system.

It is however also conceivable for the data processing device 12 itself to be designed to analyze the driving situation, where appropriate also to control the vehicle, on the basis of the result of the comparison.

FIG. 3 shows an example of a method 100 for processing sensor data in a vehicle, in particular in a rail vehicle.

In a method step S1 a position of the vehicle on the route is determined. For this purpose a position determination device can be provided, which for example receives a GPS signal and/or the like and from this determines the (current) position of the vehicle. The determined position can in this case in particular be assigned to a route section.

In a further method step S2 a scene from the area surrounding the vehicle is detected by sensors, for example with the help of a sensor device. In this case corresponding sensor data is generated. The position determined in method step S1 is preferably assigned to the generated sensor data, for example in that the position is determined at the same time as the sensor data is generated.

In a further method step S3 objects in the scene are recognized on the basis of a data processing of the sensor data, and corresponding object data that characterizes the recognized objects is generated. If for example the sensor data is image data that was generated by a camera of the sensor device, the sensor data can be evaluated with the help of an algorithm for object recognition. The resulting information in this case on the class of the recognized object and its physical properties such as position relative to the vehicle, size, structure or topology and/or the like is expediently provided at least as part of the object data, for example in the form of a feature vector.

In a further method step S4 the object data is compared with scene data that is stored in a database and that characterizes objects in the scene. Expediently to this end scene data is filtered in respect of the determined position of the vehicle. In particular, it can be provided that only scene data that can be assigned to the determined position is read out or loaded from the database—and used for the comparison.

In connection with method step S4 a degree of conformity can in particular be determined, on the basis of the comparison, which specifies the degree of conformity of the object data with the—where appropriate filtered—scene data. The degree of conformity can for example assume a high value if at least part of the object data at least substantially matches the scene data. The degree of conformity can in particular assume a high value if all objects characterized by the scene data and previously known in the area surrounding the determined position of the vehicle were also recognized in method step S3. The degree of conformity preferably assumes a high value if the properties of the recognized objects mapped by the object data at least to a high degree also match the properties of the previously known objects mapped by the scene data. It can for example be provided that the degree of conformity assumes a high value if particular, selected features in object data and scene data match. The selected features are preferably chosen such that there is a high probability that they in any case only occur in combination with one type or one instance of an object in each case. In this case the degree of conformity can indicate a specificity of the object recognition.

Conversely the degree of conformity can assume a lower value if a large part of the object data does not at least substantially match the scene data. This may for example be the case if objects are characterized by the scene data in the area surrounding the determined position of the vehicle which were not recognized in method step S3 and/or whose properties do not match.

On the basis of the degree of conformity an assessment of the reliability of the scene detection from method step S2, the data processing of the sensor data and/or of the object recognition from method step S3 can subsequently be undertaken. For example, it is possible to check whether the degree of conformity reaches or exceeds a specified threshold value for conformity. Depending on the result of this check it is possible in a further method step S5 to assess the reliability of the scene detection by sensors from method step S2, of the data processing of the sensor data and/or of the object recognition from method step S3. Alternatively or additionally, the reliability of the database can also be assessed.

For example, if the degree of conformity exceeds the specified threshold value for conformity, a degree of the reliability of the scene data can be associated with the scene detection in method step S2 and/or with the data processing and/or with the object recognition in method step S3. In other words, the sensor data processing can be assigned a particular safety standard, without a detailed analysis of the sensor data processing having to be performed for this.

In addition, in method step S5 the object data can be output to a control system, by which it can be used to control the vehicle. In particular, part of the object data which cannot be assigned for instance to nonstationary or dynamic objects that are not characterized by scene data, i.e. are unknown, can be output in the form of a surplus list as a result of the comparison from method step S4. The driving situation can then be analyzed more efficiently on the basis of the surplus list than on the basis of the original object data which characterizes all objects recognized in the area surrounding the vehicle—in other words including previously known objects that are not relevant to the control of the vehicle.

In contrast, if the degree of conformity falls below the specified threshold value for conformity, then in a further method step S6 it is possible to check—on the basis of the associated lack of trust in the object recognition from method step S3—whether a redundant system for the control of the vehicle, at least for object recognition, is operational or is working error-free. If so, the control of the vehicle can be transferred to the redundant system. Otherwise the vehicle should be transferred to a safe state.

Although the invention has been illustrated and explained in greater detail by the preferred exemplary embodiment, the invention is not restricted by the disclosed examples and other variations can be derived therefrom by the person skilled in the art, without departing from the scope of the invention.

1-15. (canceled)

16. A method for processing sensor data in a vehicle, the method comprising:
detecting a scene from a surrounding area of the vehicle by sensors and generating corresponding sensor data;
processing the sensor data for recognizing objects in the scene and generating corresponding object data that characterize the objects thus recognized;
comparing the corresponding object data with quality-assured scene data that are stored in a database and that characterize the objects in the scene; and
depending on a result of the comparing step, assessing a reliability of one or more of the following: a scene detection by the sensors, the processing of the sensor data, an object recognition, or the database.

17. The method according to claim 16, wherein the database forms a map of a route on which the vehicle is traveling, and scene data contain map data from a section of the map.

18. The method according to claim 16, wherein the step of assessing the reliability of the scene detection by sensors and/or of the data processing of the sensor data and/or of the object recognition and/or of the database comprises determining a level of reliability which is ascertained by an amount of the scene data.

19. The method according to claim 16, wherein the comparing step comprises determining a degree of conformity for a match between the object data and the scene data.

20. The method according to claim 19, which comprises performing a check as to whether the degree of conformity reaches or exceeds a specified threshold value for conformity, and controlling the vehicle based on a result of the check.

21. The method according to claim 16, which comprises:
additionally comparing the generated object data or the scene data with dynamic data provided by at least one object in the surrounding area of the vehicle; and
assessing the reliability of the scene detection by the sensors and/or of the data processing of the sensor data and/or of the object recognition and/or of the database in dependence on a result of the comparison of the provided dynamic data with the object data or the scene data; or
assessing the reliability of the dynamic data in dependence on a result of the comparison of the provided dynamic data with the object data or the scene data.

22. The method according to claim 16, which comprises:
determining a position of the vehicle on a route;
detecting the scene from the surrounding area of the vehicle at the position of the vehicle; and
comparing object data thus generated with scene data stored in the database that characterizes objects in the surrounding area of the position of the vehicle.

23. The method according to claim 22, which comprises determining hazard objects in the surrounding area of the vehicle based on a result of the comparing step and using the hazard objects for a hazard assessment.

24. The method according to claim 22, wherein the comparing step further comprises generating a surplus list of all objects characterized by the object data that are not characterized by scene data.

25. The method according to claim 22, which comprises determining further object data of a recognized object or supplementing object data based on the scene data.

26. The method according to claim 22, wherein the step of comparing the object data with the scene data comprises checking whether or not respective object properties match.

27. The method according to claim 22, which comprises determining a point in time of a detection by the sensors of the surrounding area of the vehicle and using the point in time in a comparison of the object data with the scene data.

28. The method according to claim 22, which comprises, depending on a result of the comparing step, including at least part of the scene data in a recognition of further objects in the scene on a basis of the sensor data.

29. An apparatus for processing sensor data in a vehicle, the apparatus comprising:
a sensor configured to detect a scene from a surrounding area of the vehicle and to generate corresponding sensor data; and
a data processor connected to receive the sensor data from said sensor, said data processor being configured to recognize objects in the scene based on data processing of the sensor data, and to generate corresponding object data that characterizes the objects thus recognized; and
said data processor being configured to compare the object data with quality-assured scene data stored in a database and characterizing objects in the scene and, depending on a result of a comparison, to assess a reliability of at least one of a scene detection, of the data processing of the sensor data, of an object recognition, or of the database.

30. A vehicle, comprising an apparatus for processing sensor data according to claim 29.
